(19) United States
(12) Patent Application Publication
(10) Pub. No.: US 2023/0151592 A1
(43) Pub. Date: May 18, 2023

(54) Backflow preventer for water filtering equipment

(71) Applicant: JUN HE TECHNOLOGY CO., LTD., Changhua County (TW)

(72) Inventor: CHIANG-CHUAN WANG, FUXING TOWNSHIP (TW)

(21) Appl. No.: 17/526,342

(22) Filed: Nov. 15, 2021

(51) Int. Cl. E03B 7/07; B01D 61/08; B01D 61/02; C02F 1/44

(52) U.S. Cl. CPC E03B 7/077; B01D 61/08; B01D 61/025; C02F 1/441; B01D 2313/13; B01D 2313/18; C02F 2201/005

(57) ABSTRACT

A backflow preventer for water filtering equipment, the water filtering equipment has a plurality of filtering units, the filtering units are connected among each other via at a plurality of connectors connected by at least one hose and connected to a water source via the at least one of the connectors, at least one of the connectors has a check valve set, and the check valve set has a check valve and an unidirectional valve. The check valve has an elastic tube with a duckbill valve at one end and is connected to a base at another end, and the base has a socket sleeved onto the elastic tube. The unidirectional valve has a first main portion with a larger diameter and a second main portion with a smaller diameter, the diameter of the second main portion corresponding to an inner diameter of the socket of the check valve.

### BACKGROUND of INVENTION

### Field of Invention

The present invention relates to water filtering equipment, and more particularly to a backflow preventer for water filtering equipment.

### Description of the Related Art

Rapid industrial development nowadays has relatively caused excessive pollution of air, land, and water sources. Although tap water undergoes precipitation, disinfection, and insolation procedures in the water purification plant before it is delivered to each user, these procedures cannot completely remove all kinds of pollutants, and it will endanger health when used. In order to ensure the safety of water, many people use all kinds of the water filtering equipment to filter the water before using it. Many of the water filtering equipment employs reverse osmosis (RO) water purifier.

The RO water purifier currently known has several filtering units, the filtering unit comprises the filter, the RO membrane and the pressure tank, the filtering unit is provided with the connector, so that the connector can be connected through the water pipes. Therefore the filtering unit is connected to each other, and the connector can be used to connect the water source. The water supplied from the water source is filtered through the filter unit and the RO membrane to produce pure water. At the same time, various impurities and harmful substances that cannot penetrate the filter element and the RO membrane when the concentrated waste water is discharged.

However, the above-mentioned conventional structure still has the following problems in practical applications: the connector can only provide water to pass through, but has no backstop function. Therefore, if water backflow occurs during water production, it may cause the filtering unit being damaged, and the pure water is mixed with waste water.

Therefore, it is desirable to provide a backflow preventer for water filtering equipment to mitigate and/or obviate the aforementioned problems.

### SUMMARY OF THE INVENTION

An objective of present invention is to provide a backflow preventer for water filtering equipment.

To achieve these and other objects of the present invention, A backflow preventer for water filtering equipment, the water filtering equipment has a plurality of filtering units, the filtering units connected among each other via at a plurality of connectors connected by at least one hose and connected to a water source via the at least one of the connectors, and at least one of the connectors has a check valve set, and the check valve set has a check valve and an unidirectional valve. The check valve has an elastic tube with a duckbill valve at one end and is connected to a base at another end, and the base has a socket sleeved onto the elastic tube. The unidirectional valve has a first main portion with a larger diameter and a second main portion with a smaller diameter, the diameter of the second main portion corresponding to an inner diameter of the socket of the check valve; after the check valve is placed in the first open end of the connector, the second main portion of the unidirectional valve is inserted into the socket of the check valve; and the unidirectional valve further has a through aperture passing through the first main portion and the second main portion.

Other objects, advantages, and novel features of invention will become more apparent from the following detailed description when taken in conjunction with the accompanying drawings.

### BRIEF DESCRIPTION OF DRAWINGS

FIG. 1 is a three-dimensional drawing of the water filtering equipment of a preferred embodiment according to the present invention.

FIG. 2 is a three-dimensional combination drawing of the connector and the check valve set of according to the preferred embodiment of the present invention.

FIG. 3 is a three-dimensional exploded view of the connector and the check valve set of according to the preferred embodiment of the present invention.

FIG. 4 is a sectional view of the combination of the connector and the check valve set being opened according to the preferred embodiment of the present invention.

FIG. 5 is the state drawing of the valve of according to the preferred embodiment of the present invention.

FIG. 6 is the backstop state diagram according to the preferred embodiment of the present invention.

FIG. 7 is a drawing of another preferred embodiment according to the present invention.

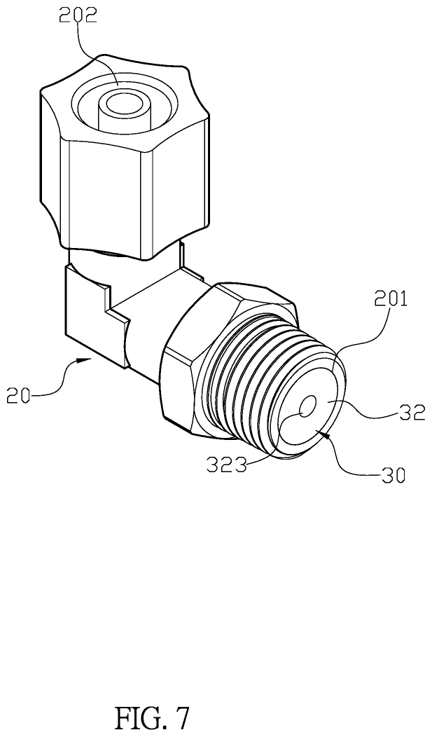

FIG. 8 is a three-dimensional exploded view of another preferred embodiment of the present invention.

FIG. 9 is a combined cross-sectional view of another preferred embodiment of the present invention.

### DETAILED DESCRIPTION OF THE PREFERRED EMBODIMENT

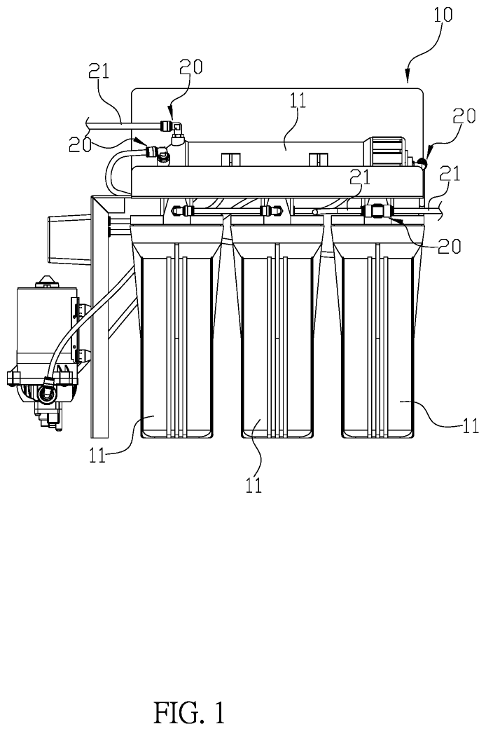

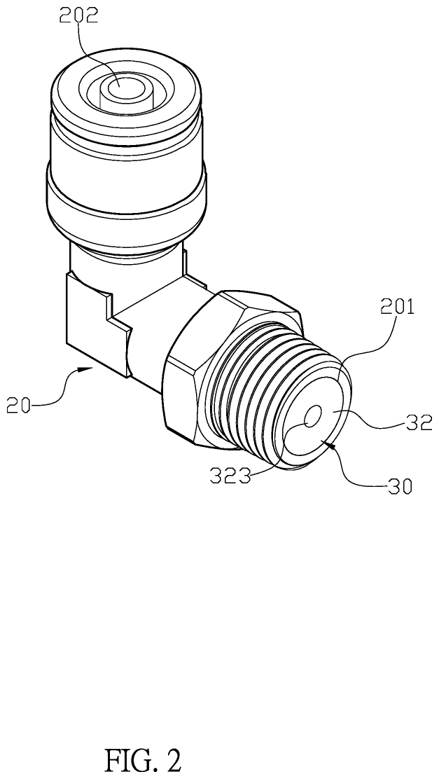

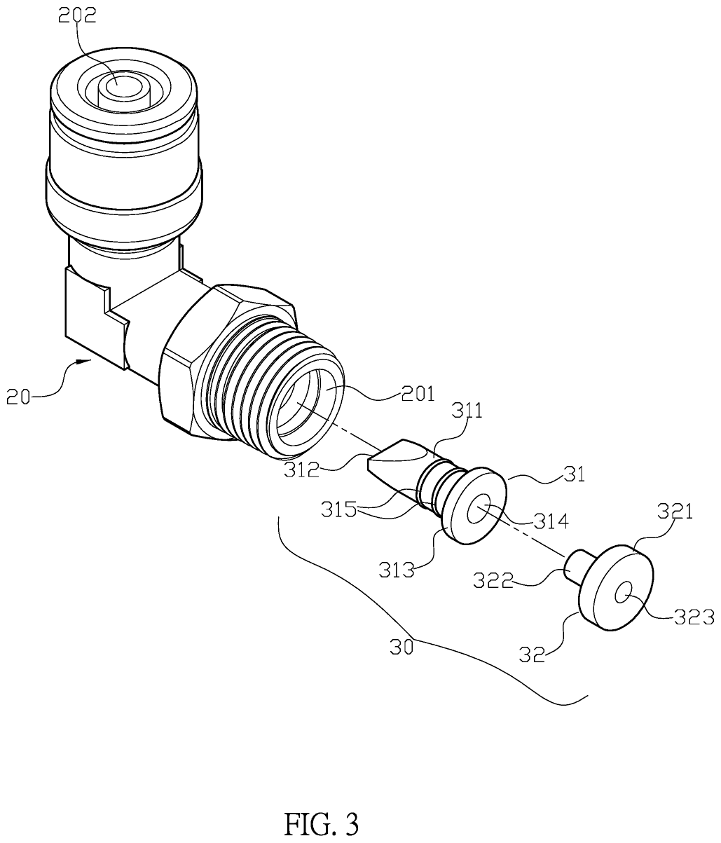

First, please refer to FIGS. 1-4. A water filtering equipment 10 comprises a plurality of filtering units 11, and the filtering units 11 are connected among each other via at a plurality of connectors 20 connected by at least one hose 21 and connected to a water source via the at least one of the connectors 20. Furthermore, at least one of the connectors 20 has a check valve set 30, and the check valve set 30 has a check valve 31 and an unidirectional valve 32. The connector 20 has a first open end 201 and a second open end 202, the first open end 201 is an input end, and the second open end 202 is an output end. The first open end 201 is configured for being coupled with the check valve set 30. The check valve 31 has an elastic tube 311, and the elastic tube 311 has an elastic tube with a duckbill valve 32 at one end and is connected to a base 313 at another end. Moreover, the base has a socket 314 sleeved onto the elastic tube 311. The unidirectional valve 32 has a first main portion 321 with a larger diameter and a second main portion 322 with a smaller diameter, and the diameter of the second main portion 322 is corresponding to an inner diameter of the socket 314 of the check valve 31. After the check valve 31 is placed in the first open end 201 of the connector 20, the second main portion 322 of the unidirectional valve 32 is inserted into the socket 314 of the check valve 31. Furthermore, the unidirectional valve 32 further has a through aperture 323 passing through the first main portion 321 and the second main portion 322. With the diameter of the through aperture 323 is significantly smaller than the diameter of the elastic tube 311 and the installation of the check valve 31, a backflow prevention can be achieved.

Moreover, the water filtering equipment 10 is a reverse osmosis (RO) water purifier, and the filtering unit 11 is a filter, a RO membrane, or a pressure barrel

Also, the check valve set 30 is configured for being installed in the connector 20.

Furthermore, the check valve set 30 is mounted on the at least one of the connectors 20 for connecting to the water source.

In addition, at least one of the connectors 20 is a quick disconnect connector, as shown in FIG. 1 to FIG. 6, so the hose 21 is able to be installed quickly.

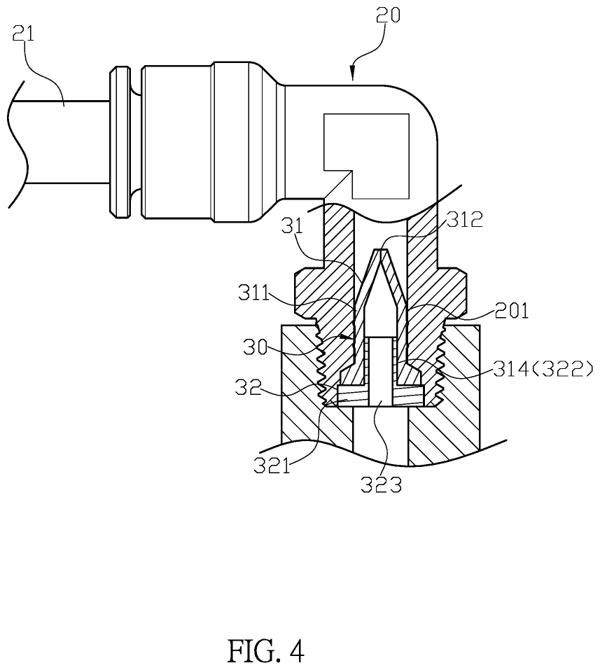

Additionally, the at least one of the connectors 20 is a locking connector, as shown in FIG. 4, so the hose 21 is able to be screwed on the connector 20.

Furthermore, the second main portion 322 of the unidirectional valve 32 is secured with the socket 314 of the check valve 31.

Moreover, the elastic tube 311 of the check valve 31 further has a protruding stopping ring 315.

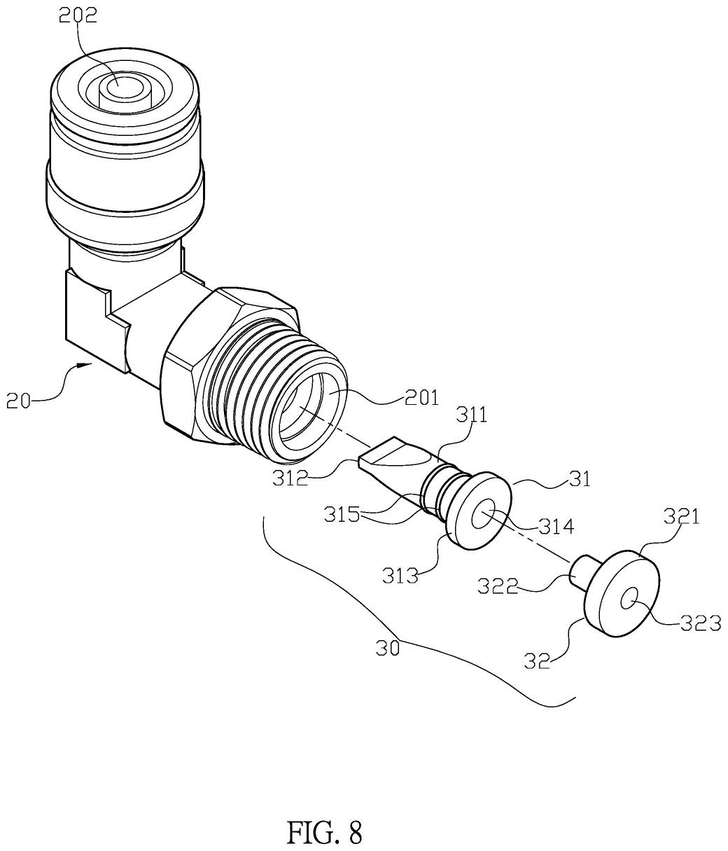

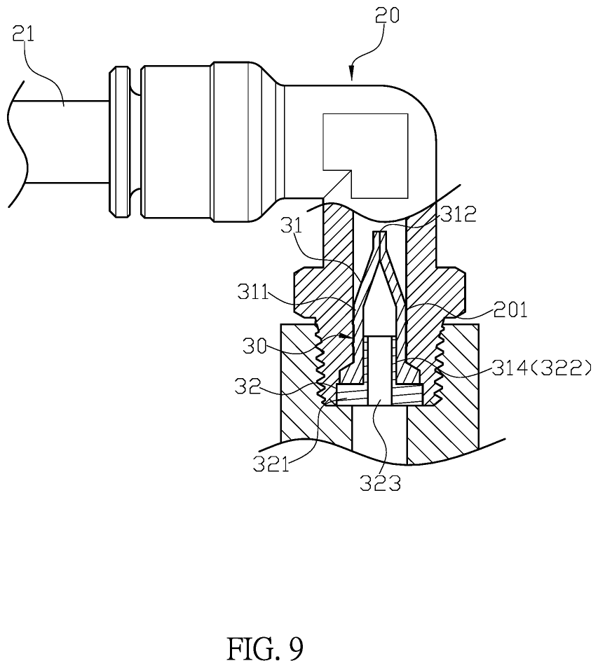

Additionally, the valve 312 of the check valve 31 is elongated as shown in FIG. 8 and FIG. 9.

Besides, the check valve 31 is made of rubber, and the rubber has an 80 Shore A hardness.

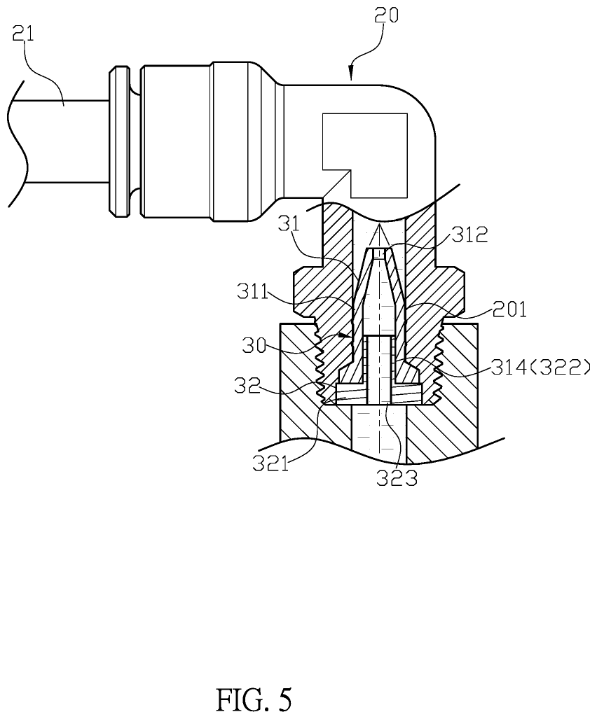

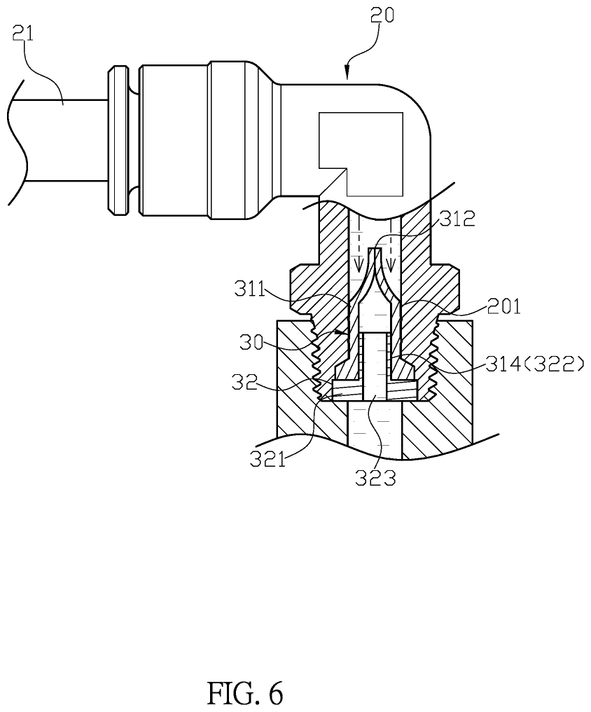

In actual use, since the check valve set 30 is plugged and secured in the first open end 201 of the connector 20. When the water source is fed into the through aperture 323, a forward hydraulic pressure with the elasticity provided by the check valve 31 allows the valve 312 to be opened smoothly, as shown in FIG. 5, so that the water can then flow from the valve 312 to the second open end 202. When the water reverses its flow, the valve 312 is affected by the reverse water pressure and closes immediately, as shown in FIG. 6, which effectively stops the reverse flow and prevents the water from flowing back in the reverse direction. When the reverse water pressure is too high, the valve 312 is forced to open, the unidirectional valve 32 combined with the check valve 31 can prevent the check valve 31 from being flushed away from the connector 20 due to the high pressure generated by the reverse flow of water, also because the through aperture 323 has a significantly smaller diameter than the diameter of elastic tube 311, which produces a higher pipe resistance at the through aperture 323 when the water flows backwards to prevent the water from breaking through the through aperture 323 in the reverse direction.

The above mentioned backflow preventer for water filtering equipment has the following advantages: 1. The installation of the check valve set 30 can prevent the water backflow during the use of the water filtering equipment 10, so that the water quality can be ensured, and it can also prevent the water filtering equipment 10 from being damaged due to the backflow of water. 2. The check valve set 30 uses the check valve 31 and the unidirectional valve 32 to cooperate with each other to maximize the anti-backflow effect and prevent the high water pressure caused by backflow pushes the check valve 31 away from the connector 20.

Although the present invention has been explained in relation to its preferred embodiment, it is to be understood that many other possible modifications and variations can be made without departing from the spirit and scope of invention as hereinafter claimed.

What is claimed is:

1. A backflow preventer for water filtering equipment, the water filtering equipment comprising a plurality of filtering units, the filtering units connected among each other via at a plurality of connectors connected by at least one hose and connected to a water source via the at least one of the connectors, and at least one of the connectors having a check valve set, the check valve set having a check valve and an unidirectional valve; wherein:
the at least one of the connectors has a first open end and a second open end;
the check valve has an elastic tube with a duckbill valve at one end and is connected to a base at another end, and the base has a socket sleeved onto the elastic tube; and
the unidirectional valve has a first main portion with a larger diameter and a second main portion with a smaller diameter, the diameter of the second main portion corresponding to an inner diameter of the socket of the check valve; after the check valve is placed in the first open end of the connector, the second main portion of the unidirectional valve is inserted into the socket of the check valve; and the unidirectional valve further has a through aperture passing through the first main portion and the second main portion.

2. The backflow preventer for water filtering equipment as claimed in claim 1, wherein the water filtering equipment is a reverse osmosis (RO) water purifier, and the filtering unit is a filter, a RO membrane, or a pressure barrel.

3. The backflow preventer for water filtering equipment as claimed in claim 1, wherein the first open end of the at least one of the connectors is an input end, and the second open end of the at least one of the connectors is an output end.

4. The backflow preventer for water filtering equipment as claimed in claim 1, wherein the check valve set is mounted on the at least one of the connectors for connecting to the water source.

5. The backflow preventer for water filtering equipment as claimed in claim 1, wherein the check valve set is mounted on the at least one of the connectors for connecting to the filtering unit.

6. The backflow preventer for water filtering equipment as claimed in claim 1, wherein the at least one of the connectors is a quick disconnect connector.

7. The backflow preventer for water filtering equipment as claimed in claim 1, wherein the at least one of the connectors is a locking connector.

8. The backflow preventer for water filtering equipment as claimed in claim 1, wherein the second main portion of the unidirectional valve is secured with the socket of the check valve.

9. The backflow preventer for water filtering equipment as claimed in claim 1, wherein the elastic tube of the check valve further has a protruding stopping ring.

10. The backflow preventer for water filtering equipment as claimed in claim 1, wherein the check valve is made of rubber, and the rubber has an 80 Shore A hardness.
